(19) United States
(12) Patent Application Publication
(10) Pub. No.: US 2026/0218806 A1
(43) Pub. Date: Jul. 30, 2026

(54) ELECTROMECHANICAL ACTUATING DEVICE, AND FLUID DISTRIBUTION VALVE COMPRISING SUCH AN ELECTROMECHANICAL ACTUATING DEVICE

(71) Applicant: VERNET, OLLAINVILLE (FR)

(72) Inventors: Benoit Robert Simon MAUGERARD, BRUNOY (FR); Gaël Serge MILLET, Arpajon (FR)

(21) Appl. No.: 19/158,252

(22) PCT Filed: Feb. 26, 2024
(86) PCT No.: PCT/EP2024/054810

§ 371 Date: Aug. 20, 2025

(30) Foreign Application Priority Data
Feb. 27, 2023 (FR) FR2301791

(51) Int. Cl. F16K 31/04; F16K 11/087; F16K 31/53

(52) U.S. Cl. CPC F16K 31/043; F16K 11/0873; F16K 31/535

(57) ABSTRACT

This actuating device includes a support, an electric motor, borne by the support and provided with a drive output, rotatable around a motor axis and provided with a leading gearing, and a mechanical transmission system, supported by the support and connecting the drive output to a shutter of a fluid distribution valve so that a rotation of the drive output forces the shutter to move in order to regulate a fluid through the valve. The transmission system includes a gear wheel, supported by the support rotatable about a central gear wheel axis and provided with: a first driven gearing, designed to mesh with the leading gearing when the gear wheel axis and the motor axis are parallel; a second driven gearing, designed to mesh with the leading gearing when the gear wheel axis and the motor axis are perpendicular; and a driving hub, centered on the gear wheel axis.

The present invention relates to an electromechanical actuating device for a fluid distribution valve. It also relates to a fluid distribution valve comprising such an electromechanical actuating device.

In particular, the invention involves valves for fluid circulation circuits, specifically cooling fluid, embedded on vehicles with thermal, electric, hydrogen, or hybrid engines. The fluid flows through the valve by means of its drive in the circulation circuit under the effect of a pump, typically electric. The valves concerned here include a shutter that is mounted mobile, for example in rotation around an axis, in a valve housing, to regulate a fluid flow through the housing between an inlet and outlets of the housing, this shutter being driven in movement by an electromechanical actuating device, associated with the valve. This electromechanical actuating device typically associates an electric motor, provided with a rotary drive output, and a mechanical transmission system, connecting the drive output to the shutter to drive it in movement. The drive output meshes with a gear wheel provided “at the input” of the mechanical transmission system.

In practice, the relative arrangement of the electric motor and the mechanical transmission system depends on the installation constraints of the electromechanical actuating device with respect to the valve and, more generally, the installation constraints of the fluid circulation circuit to which this valve belongs, or more globally, the installation constraints in the vehicle environment. As a result, the aforementioned gear wheel must be changed, for a given electric motor, depending on the relative orientation between the drive output and the rotational axis of this gear wheel. This requires managing several possible versions for this gear wheel, which incurs costs for parts, as well as efforts to design the gear formed between the drive output of the electric motor and the gear wheel, to adapt the electromechanical actuating device to different installation arrangements.

It is known from US 2020/200251 A1 to use an electromechanical actuating device whose transmission system comprises two gear wheels, whose respective axes of rotation are perpendicular. However, this solution imposes an actuating device arrangement wherein the axis of rotation of the drive output and the axis of the output of the transmission system are perpendicular to each other.

The purpose of the present invention is to propose an improved electromechanical actuating device that can easily adapt to different installation arrangements.

To this end, the invention relates to an electromechanical actuating device for a fluid distribution valve, as defined in claim 1.

The invention also relates to a fluid distribution valve, as defined in claim 9.

One of the ideas underlying the invention is to integrate into the gear wheel, meshed by a leading gearing of the drive output of the electric motor, not just one driven gearing, but at least two different driven gearings, which are selectively used according to the relative orientation of the motor axis of the drive output and the wheel axis of the gear wheel. Thus, by means of the invention, when the motor axis and the wheel axis are parallel to each other, the leading gearing of the drive output meshes with a first of these driven gearings of the gear wheel, while leaving the other driven gearings free, whereas when the motor axis and the wheel axis are perpendicular to each other, the leading gearing of the drive output meshes with a second of these driven gearings of the gear wheel, while leaving the other driven gearings free. In this way, the same gear wheel is used indifferently, at least according to whether the wheel axis and the motor axis are parallel or perpendicular to each other. This reduces the diversity of parts in the mechanical transmission system and enables easy adaptation of the electromechanical actuating device according to the invention to various installation arrangements, specifically with respect to the valve to which the shutter, driven in movement by this electromechanical actuating device, belongs. In particular, without having to change the gear wheel, the arrangement of the electric motor relative to the rest of the electromechanical actuating device and relative to the valve is modifiable between two orientations, at 90° to each other, which increases the adaptation capabilities of the actuating device for installation thereof in crowded environments, such as the environments of fluid circulation circuits, embedded on vehicles. Moreover, certain aspects of the gear wheel are advantageously provided to further improve the electromechanical actuating device, as explained in more detail below.

Additional advantageous features of the electromechanical actuating device according to the invention are defined in the other claims.

The invention will be better understood from the following description, given solely by way of example and with reference to the drawings, wherein:

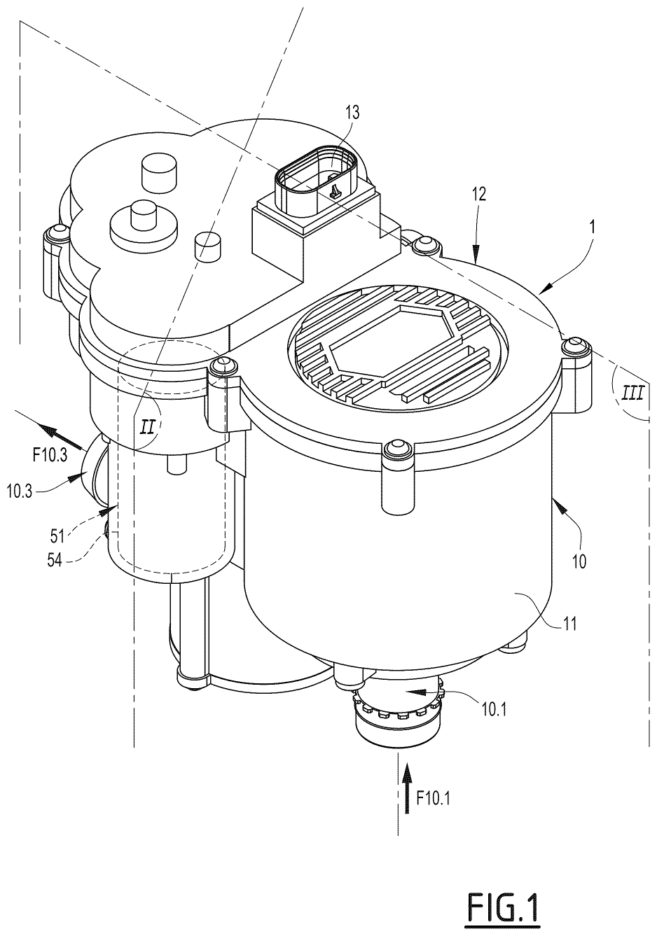

FIG. 1 is a perspective view of a valve according to the invention;

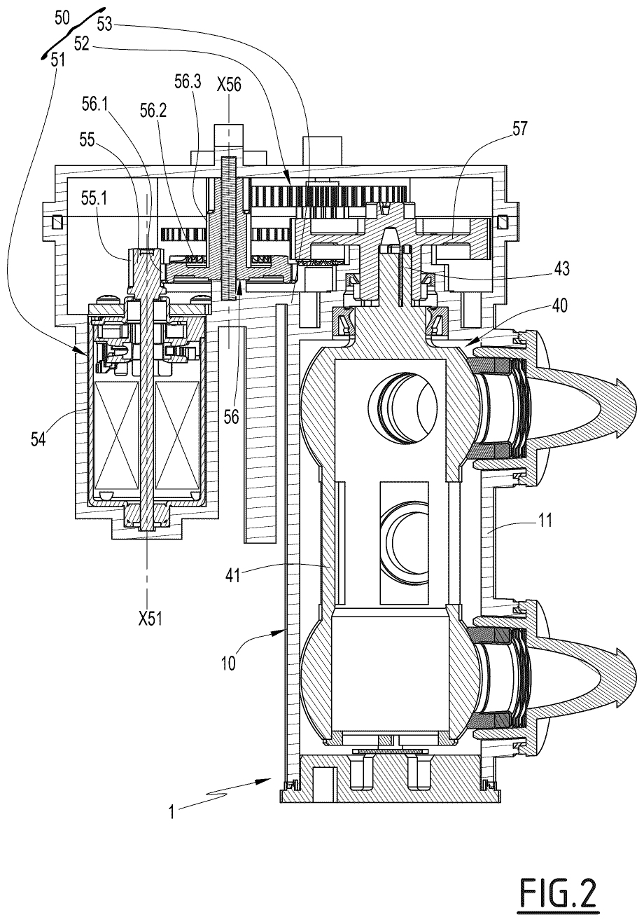

FIG. 2 is a section along plane II of FIG. 1;

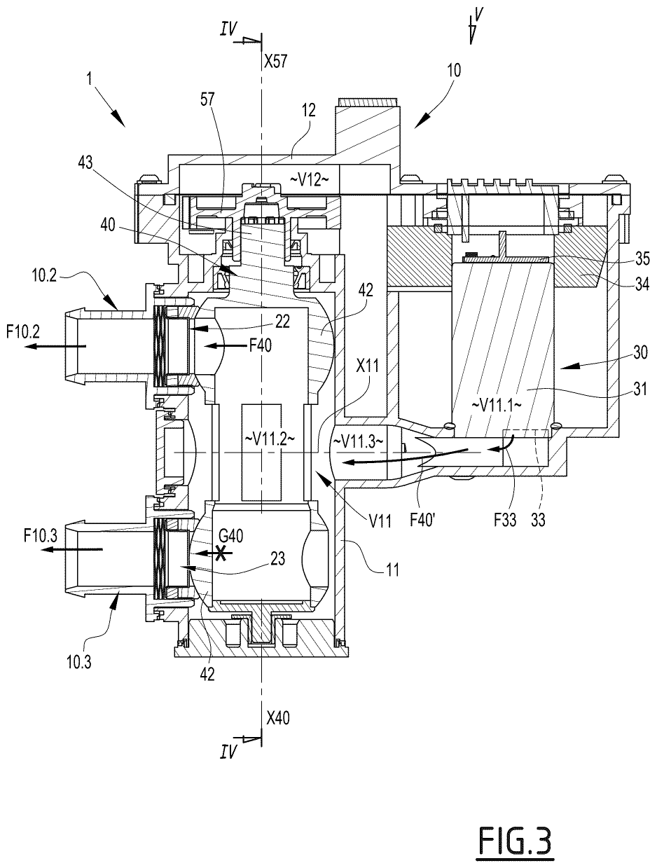

FIG. 3 is a section along plane III of FIG. 1;

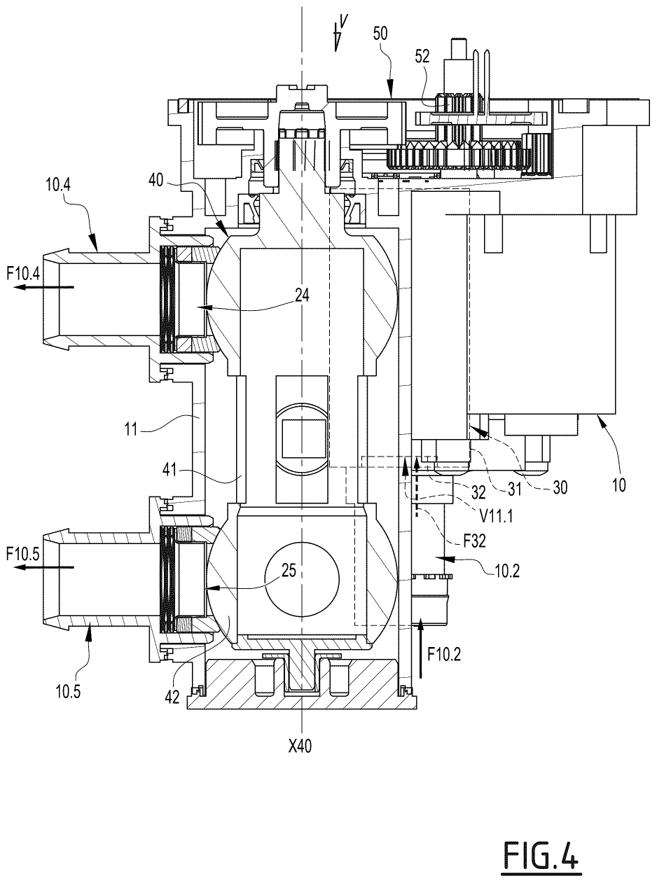

FIG. 4 is a section along line IV-IV of FIG. 3, after removal of a cover of the valve;

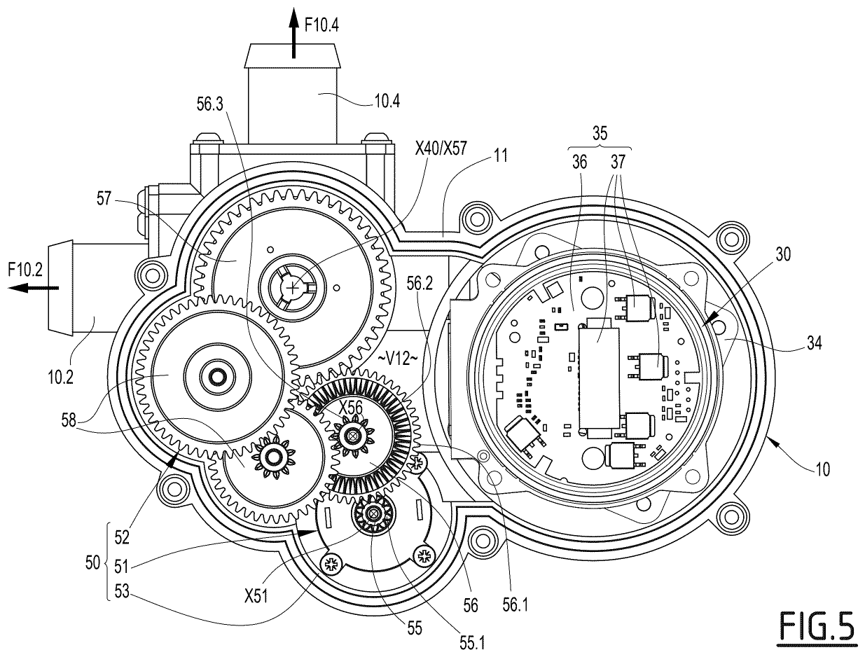

FIG. 5 is an elevation view according to arrow V of FIG. 4;

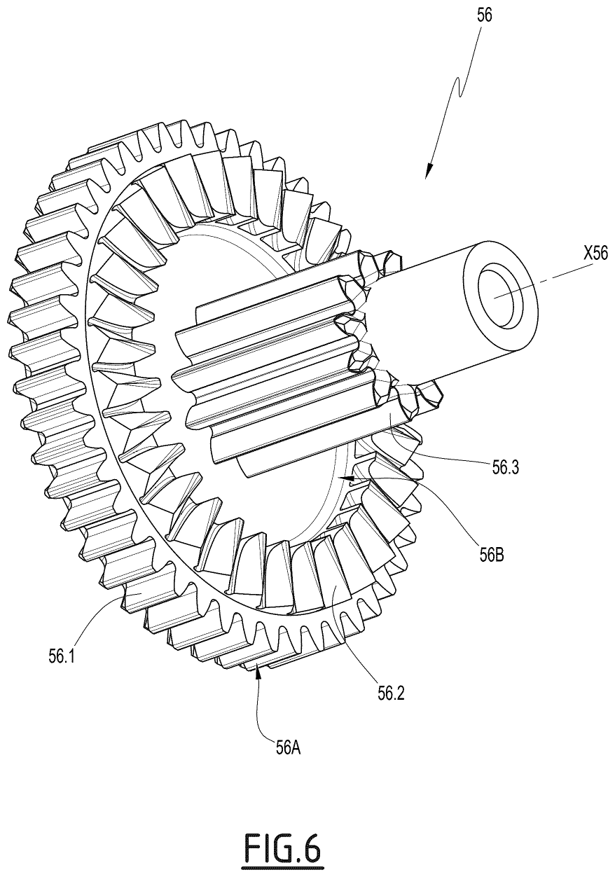

FIG. 6 is a perspective view of a gear wheel belonging to an electromechanical actuating device of the valve of the previous figures;

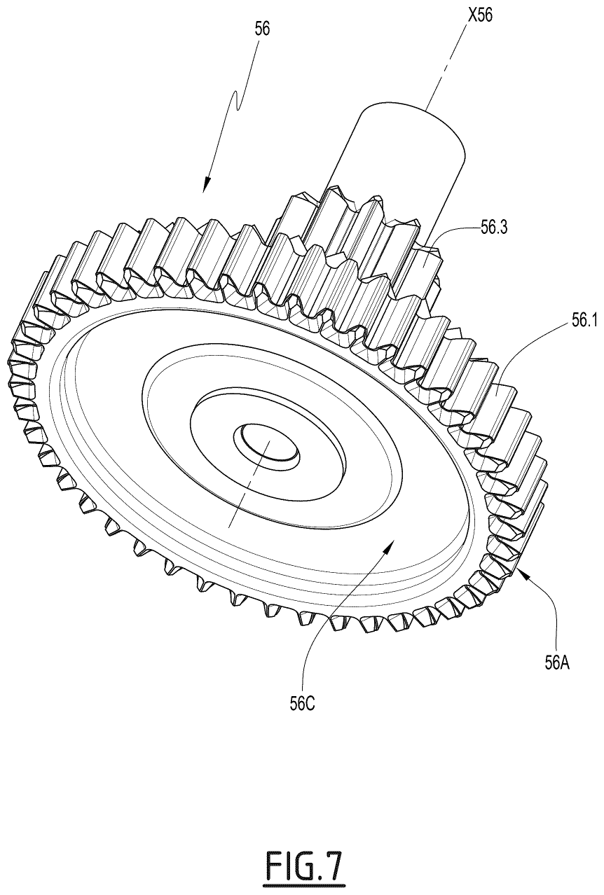

FIG. 7 is a view similar to FIG. 6, from a different observation angle than that of FIG. 6;

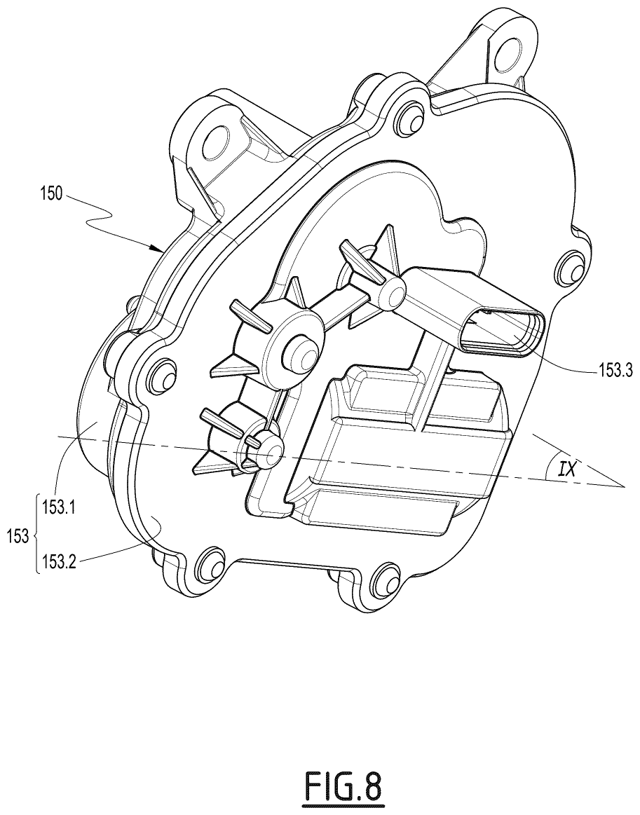

FIG. 8 is a perspective view of an electromechanical actuating device according to the invention, for a valve different from that shown in FIGS. 1 to 5;

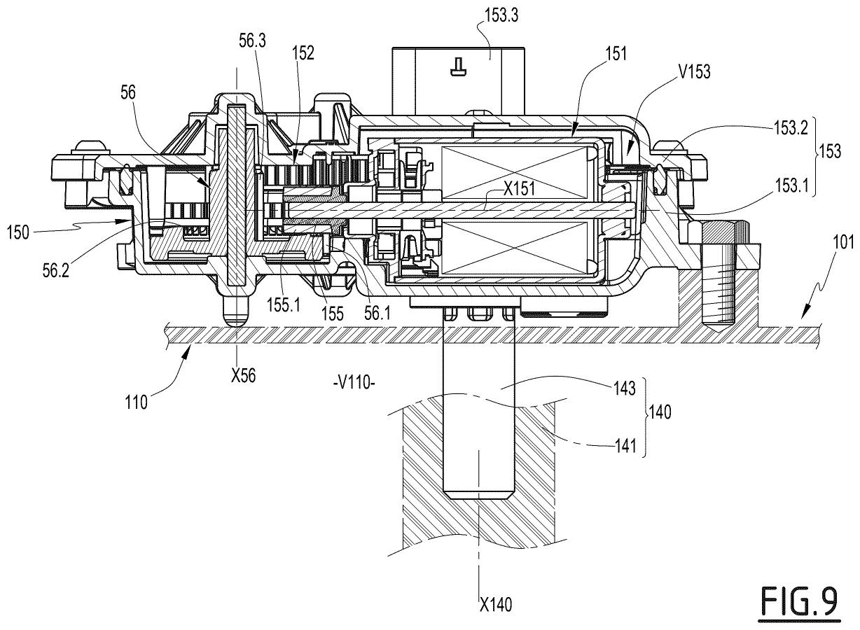

FIG. 9 is a section along plane IX of FIG. 8;

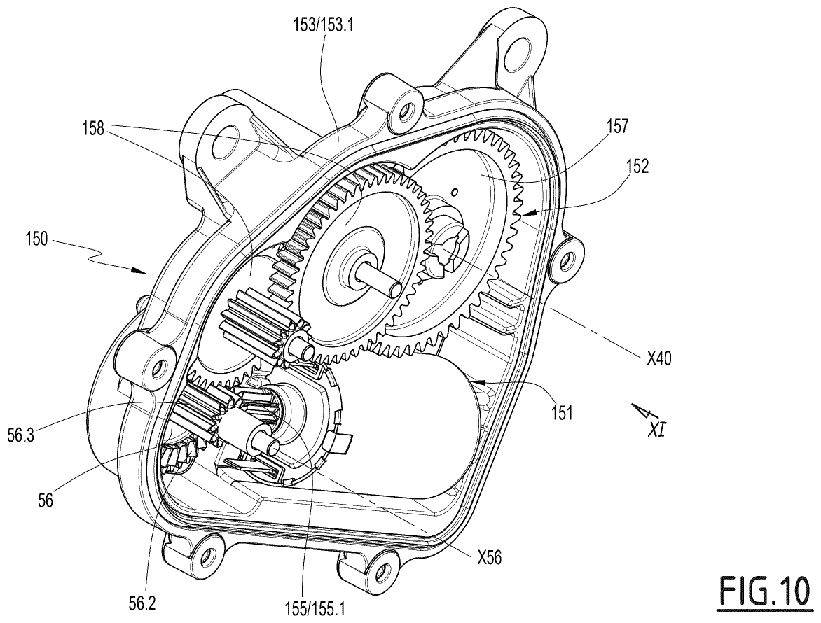

FIG. 10 is a view similar to FIG. 8, after removal of a part of the electromechanical actuating device;

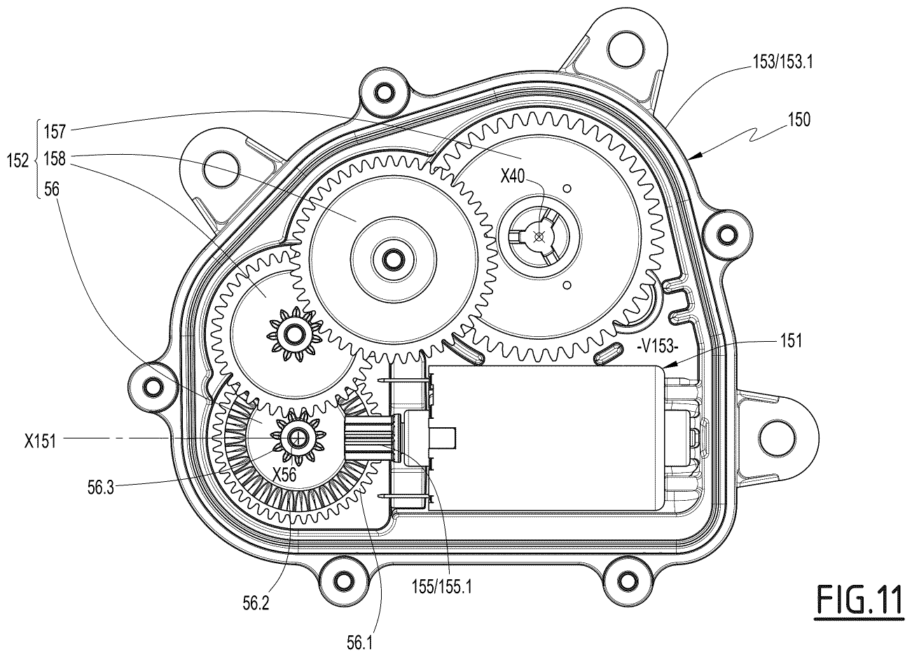

FIG. 11 is an elevation view according to arrow XI of FIG. 10;

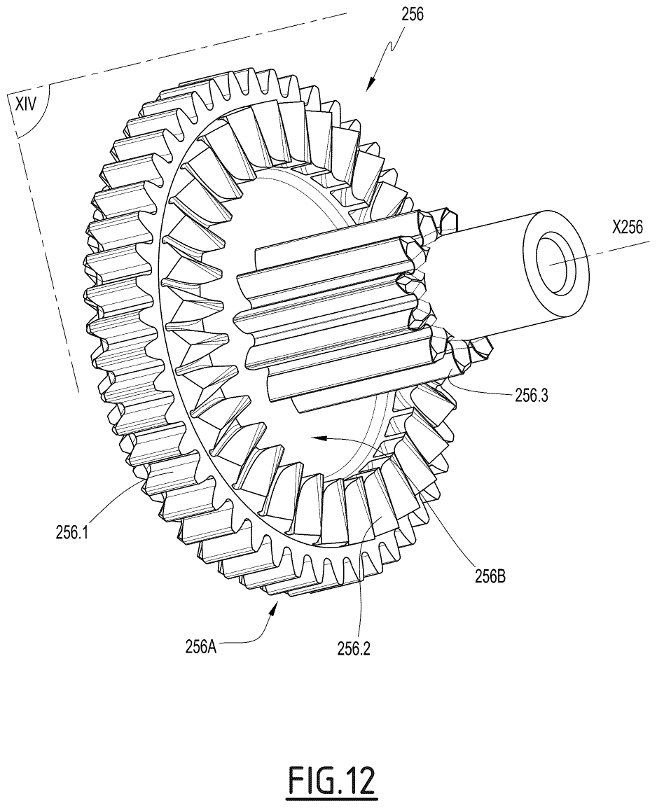

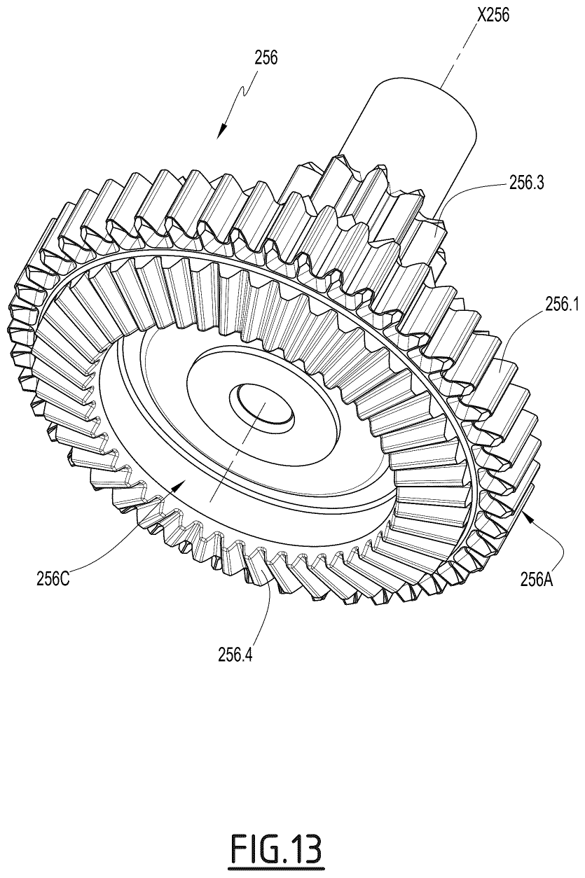

FIGS. 12 and 13 are views respectively similar to FIGS. 6 and 7, illustrating an alternative embodiment for the gear wheel of FIGS. 6 and 7; and

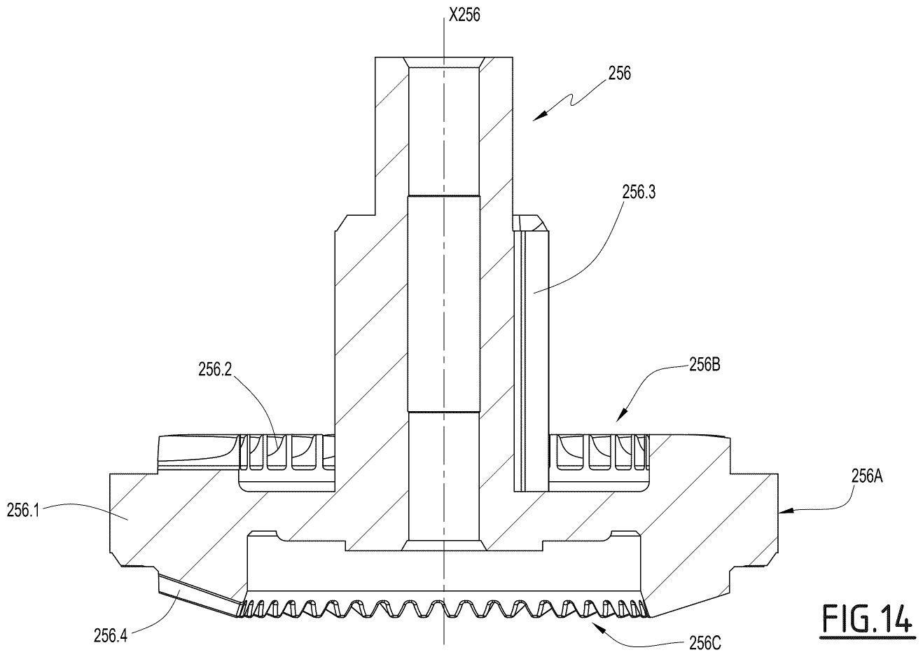

FIG. 14 is a section along plane XIV of FIG. 12.

FIGS. 1 to 5 show a motorized fluid distribution valve, referenced 1. This valve 1 is adapted to be integrated into a fluid circulation circuit, specifically a cooling fluid. The valve 1 is used in a cooling circuit of a vehicle's engine, for example, with this engine being thermal, electric, hydrogen, or hybrid.

The valve 1 includes a housing 10 through which the fluid to be distributed by the valve 1, in other words to be regulated, is intended to flow. To this end, as clearly visible in FIGS. 1 to 5, the housing 10 includes a body 11, which delimits an internal volume V11 through which the fluid passes through the housing 10, as well as an inlet 10.1 and outlets, here four in number and referenced 10.2, 10.3, 10.4, and 10.5 respectively. The inlet 10.1 can communicate with the outlets 10.2 to 10.5 through the body 11 via the internal volume V11 of the latter, with the effective communication between the inlet 10.1 and one or more of the outlets 10.2 to 10.5 being operated by components of the valve, as detailed below. In service, the fluid enters the internal volume V11 through the inlet 10.1, as schematically indicated by arrow F10.1 in the figures, and the fluid exits the internal volume V11 through the outlets 10.2 to 10.5, as schematically indicated in the figures by arrows F10.2, F10.3, F10.4, and F10.5 respectively.

The embodiment of the body 11 is not limiting as long as this body 11 is sufficiently rigid to fixedly delimit the internal volume V11. In particular, the body 11 can be made up of several parts that are fixedly assembled to each other, by any appropriate means. Alternatively, as in the example illustrated in FIGS. 1 to 5, the body 11 is made of a single piece.

In the embodiment considered in the figures and for reasons that will become apparent later, the internal volume V11 of the body 11 is divided, as clearly visible in FIGS. 3 and 4, between:
a sub-volume V11.1 into which the inlet 10.1 opens,
a sub-volume V11.2 into which the outlets 10.2 to 10.5 open, and
a passage V11.3 that directly connects the sub-volumes V11.1 and V11.2 to each other.

Also in the embodiment considered in the figures, the housing 10 further includes a cover 12 which, in the assembled state of the valve 1, is fixedly attached to the body 11, as clearly visible in FIGS. 1 to 3. The cover 12 does not appear in FIGS. 4 and 5, since the valve 1 is shown without this cover. This cover 12 and the body 11 delimit between them a compartment V12 which, in the assembled state of the valve 1, is sealed off from the internal volume V11, thus forming an internal region of the housing 10, which is sealed off from the fluid circulating through the valve 1 via the internal volume V11. To this end, the cover 12 is sealed to the body 11 by any appropriate means, specifically by removable fastening means, to facilitate the assembly and maintenance of components of the valve 1 placed inside the compartment V12, with these components detailed below.

Also in the embodiment considered in FIGS. 1 to 5, the valve 1 includes a pump 30, inside the housing 10, allowing the aforementioned fluid to be driven through the housing 10 via the internal volume V11. This pump 30 includes a hydraulic part 31, the embodiment of which is not limiting as long as this hydraulic part 31 acts on the fluid to drive it through the housing 10 via the internal volume V11. This hydraulic part 31 of the pump 30 is provided with an intake 32, that is to say, an opening, through which the fluid to be pumped by the pump 30 flows towards the inside of this hydraulic part 31 and thus enters the hydraulic part 31, and a discharge 33, that is to say, an opening through which the fluid pumped by the pump 30 flows towards the outside of the hydraulic part 31 and thus exits this hydraulic part 31. In the assembled state of the valve 1, the hydraulic part 31 of the pump 30 is supported by the body 11 of the housing 10, being arranged in the sub-volume V11.1 so that the intake 32 opens into the inlet 10.1 of the housing 10 so that all the fluid entering the internal volume V11, via the inlet 10.1, is directly admitted into the hydraulic part 31, as schematically indicated by arrow F32 in FIG. 4, on the one hand, and, on the other, the discharge 33 opens into the passage V11.3 so that all the fluid discharged by the hydraulic part 31 is directly sent into the entrance of this passage V11.3, as schematically indicated by arrow F33 in FIG. 3. In practice, the hydraulic part 31 is assembled to the housing 10 with the interposition of sealing joints, which form ad hoc sealing lines at the intake 32 and the discharge 33 respectively. Moreover, in the embodiment considered in the figures, the pump 30 helps to delimit the compartment V12, jointly with the body 11 and the cover 12, and, for this purpose, includes a flange 34 or similar, through which a casing of the hydraulic part 31 is secured to the body 11 and on which the cover 12 is mounted in a sealed manner.

In all cases, the pump 30 is electric, in the sense that its hydraulic part 31 is actuated by an electric motor, integrated into the pump. In practice, multiple embodiments are conceivable for this electric motor and for its integration into the rest of the pump 30, without this aspect of the pump being limiting. In all cases, the pump 30 includes an electronic part 35 that controls the hydraulic part 31 by piloting the electric motor of the pump 30. In the embodiment considered in the figures, the electronic part 35 includes a printed circuit board 36, which is here fixedly supported by the casing of the hydraulic part 31, and various electronic components 37, which are mounted on the printed circuit board 36 and which are designed to control the electric motor of the pump 30 by sending it electrical power and control signals. The functional and structural specifics of the electronic part 35 are not limiting and will not be detailed further here. In the assembled state of the valve 1, the electronic part 35 is advantageously housed inside the compartment V12, as clearly visible in FIGS. 3 and 5.

The valve 1 also includes a shutter 40 that is supported by the housing 10, being arranged in the internal volume V11, more precisely, here, in the sub-volume V11.2, and being movable therein relative to the housing 10, here in rotation around a shutter axis X40. The shutter 40, by its mobility, here in rotation around the shutter axis X40, enables regulating the flow of fluid through the housing 10 by controlling the opening/closing of the outlets 10.2 to 10.5 of the housing 10. In the assembled state of the valve 1, the shutter 40 interacts by sliding sealing contact with seat devices 22, 23, 24, and 25, which are associated with the outlets 10.2 to 10.5 respectively, and which are supported by the housing 10, so that, for each of the seat devices 22 to 25, the shutter 40, depending on its position relative to the housing 10, here around the shutter axis X40, is designed to:
either control the opening of the outlet 10.2 to 10.5 associated with the seat device 22 to 25, by allowing the fluid to flow through the seat device from the sub-volume V11.2 to this outlet, as schematically illustrated by arrow F40 in FIG. 3 for the outlet 10.2,
or control the closing of the outlet 10.2 to 10.5 associated with the seat device 22 to 25, by preventing the fluid from reaching this outlet from the sub-volume V11.2 through the seat device, as illustrated by the barred arrow G 40 in FIG. 3 for the outlet 10.3.

Moreover, at least in each of the positions of the shutter 40 relative to the housing 10, here around the shutter axis X40, which control the opening of at least one of the outlets 10.2 to 10.5, the shutter 40 allows the fluid to enter the sub-volume V11.2 from the passage V11.3, as schematically indicated by arrow F40 in FIG. 3.

Thus, more globally, the shutter 40 enables regulating the fluid through the valve 1, that is to say, distributing the fluid entering the internal volume V11 of the body 11 of the housing 10 selectively into one or more of the outlets 10.2 to 10.5 of the housing.

In the embodiment considered in FIGS. 1 to 5, the shutter 40 includes a generally tubular body 41, which is centered on the shutter axis X40. Here, the tubular body 41 fixedly supports spherical reliefs 42 on its outer lateral face, which are centered on the shutter axis X40 and which are distributed so that, during the movement of the shutter around the shutter axis X40, each of the spherical reliefs 42 interacts, by shape complementarity, with one or more of the seat devices 22 to 25, to control the opening/closing of the outlets 10.2 to 10.5. Of course, other embodiments than that detailed above are conceivable for the shutter 40, such as a paddle shutter.

In all cases, to control the movement of the shutter 40 and thus control the opening/closing of the outlets 10.2 to 10.5 of the housing 10, the valve 1 includes an actuating device 50. This actuating device 50 is electromechanical in the sense that this actuating device is designed to transform the electrical energy supplying it into a mechanical driving force, applied to the shutter 40 to drive it relative to the housing 10, here in rotation around the shutter axis X40. In the assembled state of the valve 1, the actuating device 50 is supported by the housing 10, being at least partially housed in the compartment V12.

The actuating device 50 includes an electric motor 51 and a mechanical transmission system 52, which connects the electric motor 51 to the shutter 40, as explained in detail below.

As clearly visible in FIGS. 2 and 5, the electric motor 51 and the transmission system 52 are supported by a support 53 of the actuating device 50. In the assembled state of the valve 1, the support 53 is fixedly attached to the housing 10. In the embodiment considered in FIGS. 1 to 5, the support 54 is advantageously integrated into the housing 10, being formed here by a part of the body 11 and/or a part of the cover 12 of the housing 10, as clearly visible in FIG. 2. More generally, the embodiment of the support 53 is not limiting as long as this support 53 constitutes a mounting and guiding structure for the components constituting the electric motor 51 and the transmission system 52, with this structure being fixedly attached to the housing 10, in the assembled state of the valve 1, by any appropriate means.

The electric motor 51 typically comprises a casing 54, inside which electromechanical components of the electric motor 51 are arranged, which transform the electrical energy supplying it into a driving force that is provided at a drive output 55 of the electric motor 51, this drive output 55 extending through the casing 54. The casing 54 is securely mounted to the support 53 by any appropriate means: here, the casing 54 is fixedly mounted in a dedicated housing of the body 11, belonging to the compartment V12, as schematically indicated in FIG. 1 and as clearly visible in FIG. 2.

In all cases, the drive output 55 is rotatable around a motor axis X51 relative to the support 53 and relative to the housing 10 in the assembled state of the valve 1. As clearly visible in FIGS. 2 and 5, the drive output 55 is provided with a leading gearing 55.1, at its part emerging from the casing 54, which extends all around the motor axis X51.

The transmission system 52 connects the drive output 55 to the shutter 40 so that a rotation of the drive output 55 around the motor axis 51 drives the shutter 40 in movement to regulate the fluid through the valve 1, here driving the shutter 40 in rotation around the shutter axis X40. In the embodiment illustrated in FIGS. 1 to 5, the drive output 55 and the transmission system 52 are advantageously arranged in the compartment V12.

As clearly visible in FIGS. 2 and 5, the transmission system 52 includes a succession of gear wheels that mesh successively with each other, each of these gear wheels being supported by the support 53 in a mobile manner in rotation around a wheel axis on which the corresponding wheel is centered. In the embodiment considered in the figures, the respective wheel axes of the gear wheels of the transmission system 52 are parallel to each other and to the shutter axis X40. A first gear wheel of this succession of gear wheels, which is referenced 56 and whose wheel axis is referenced X56, is in a meshing engagement with the drive output 55 and thus constitutes “the input” of the transmission system 52, with it being noted that the wheel axis X56 is parallel to the motor axis X51, as clearly visible in FIG. 2. The succession of gear wheels includes a gear wheel 57, at “the output” of the transmission system 52, whose wheel axis is referenced X57 and which engages the shutter 40 for the purpose of driving the latter in movement: in the embodiment illustrated in FIGS. 1 to 5, the gear wheel 57 thus engages a head 43 of the shutter 40, formed at an axial end of its tubular body 41, being here rotationally attached to this head 43 around the shutter axis X40 that is substantially coincident with the wheel axis X57. The gear wheel 56 and the gear wheel 57 are connected to each other by intermediate gear wheels 58 belonging to the aforementioned succession of gear wheels, these intermediate gear wheels 58 here being two in number. The gear train formed by the gear wheels 56, 57, and 58 enables multiplying the movement transmitted from the drive output 55 to the shutter 40. In practice, the specifics of this gear train are not limiting and are adapted both to the desired transmission ratio between the drive output 55 and the shutter 40 and to the kinematics of the shutter 40.

In all cases, the gear wheel 56, which is shown alone in FIGS. 6 and 7, has the specificity of being provided with two driven gearings that are distinct from each other, namely a first driven gearing 56.1 and a second driven gearing 56.2. The driven gearings 56.1 and 56.2 each extend around the wheel axis X56 but are located in different regions of the gear wheel 56 so that, in the assembled state of the actuating device 50, the first driven gearing 56.1 meshes with the leading gearing 55.1 of the drive output 55 while the second driven gearing 56.2 remains free, as clearly visible in FIGS. 2 and 5. The relevance of the second driven gearing 56.2 will become apparent a little later.

In the embodiment considered in FIGS. 6 and 7, the first driven gearing 56.1 is arranged on a lateral face 56A of the gear wheel 56, this lateral face 56A extending in the direction of the wheel axis X56 and connecting two frontal faces 56B and 56C of the gear wheel 56, which extend transversely, or even perpendicularly to the wheel axis X56. The first driven gearing 56.1 is advantageously a straight or helical gearing, specifically centered on the wheel axis X56.

As clearly visible in FIG. 6, the second driven gearing 56.2, for its part, is arranged on the frontal face 56B of the gear wheel 56. The second driven gearing 56.2 is advantageously a dog-clutch faced gearing, specifically centered on the wheel axis X56 and with dog clutching following this wheel axis X56.

Moreover, the gear wheel 56 includes a driving hub 56.3, which is centered on the wheel axis X56 and which extends from the frontal face 56B in the opposite direction to the frontal face 56C. Thus, as clearly visible in FIG. 6, the frontal face 56B supports both the driven gearing 56.2 and the driving hub 56.3 in a protruding manner. In the assembled state of the actuating device 50, the driving hub 56.3 meshes with one of the intermediate gear wheels 58, as clearly visible in FIG. 5.

Moreover, the actuating device 50, in particular its electric motor 51, and the pump 30, in particular its electronic part 35, are advantageously electrically connected to respective connectors, here inside the compartment V12, or, as here, to a single connector 13, this or these connectors being supported by the housing 10. In the example illustrated in the figures, the single connector 13 is firmly and tightly secured to the cover 12, by any appropriate means. In all cases, the connector or connectors are designed to be connected, outside the valve 1, each to an external harness, not shown, to electrically connect the valve 1 to one or more external units, which are not shown and which include a power supply source. This power supply source, whose embodiment is not limiting, comprises a battery, for example, that is embedded in the vehicle to the cooling circuit of which the valve 1 belongs. According to one possible embodiment, the aforementioned external units include one or more control and/or supervision units, such as an onboard computer of the vehicle to the cooling circuit of which the valve 1 belongs: the or one of these control and/or supervision units is advantageously designed to control the electric motor 51, by sending it ad hoc control electrical signals via the external harness. According to another possible embodiment, the control of the electric motor 51 is operated by an electronic device, which belongs to the valve 1 and which is housed in the compartment V12, being specifically integrated into the electrical connection between the connector 13 and the electric motor 51: this electronic device, which is not shown in the figures, can be either partially coupled to the electronic part 35 of the pump 30 or totally separate from the latter, in all cases being adapted to send the electric motor 51 electrical control signals and, where applicable, power supply signals.

FIGS. 8 to 11 show an electromechanical actuating device 150, which has the same technical purpose as the actuating device 50, as explained in detail below. The actuating device 150 is designed to equip a fluid distribution valve, which is only partially and schematically represented in FIG. 9, there being referenced 101.

As schematically indicated in FIG. 9, the valve 101 comprises a housing 110 that is functionally similar to the housing 10 of the valve 1, in the sense that the housing 110 defines an internal volume V11 through which a fluid passes through the housing 110, like the internal volume V11 for the housing 10 of the valve 1. In practice, following similar considerations to those developed above in connection with the internal volume V11, the internal volume V110 of the housing 110 is connected to the outside of the housing 110 by a housing inlet through which the fluid enters the internal volume V110, and by housing outlets through which the fluid exits the internal volume V110, which are controlled in opening/closing by a shutter 140 of the valve 101, functionally similar to the shutter 40 of the valve 1. As schematically illustrated in FIG. 9 where the shutter 140 is only partially represented, this shutter 140 includes a main body 141, which is arranged in the internal volume V110 and which is movable therein relative to the housing 110 to control the opening/closing of the outlets of the housing 110. In the assembled state of the valve 101, the shutter 140 is driven by the actuating device 150 in movement relative to the housing 110, specifically at least partly in rotation around a shutter axis X140.

As clearly visible in FIGS. 8 to 11, the actuating device 150 comprises an electric motor 151 and a mechanical transmission system 152, which are supported by a support 153 of the actuating device 150.

The support 153 is functionally similar to the support 53 of the actuating device 50, in the sense that this support 153 ensures the mounting and guiding of components of the electric motor 151 and the transmission system 152, while being fixedly attached to the housing 110 in the assembled state of the valve 101. The support 153 is structurally different from the support 53 in that the support 153 is not integrated into the housing 110, but is fixedly attached to the latter by any appropriate means. In the embodiment example considered in FIGS. 8 to 11, the support 153 alone delimits a sealed compartment V153, inside which the electric motor 151 and the transmission system 152 are advantageously housed and from which a head 143 of the shutter 140 extends into the internal volume V110 of the housing 110, successively passing through the support 153 and the housing 110, as schematically illustrated in FIG. 9. Here, the head 143 extends from the compartment V153 to the internal volume V110 following the shutter axis X140 and, inside the compartment V153, is kinematically attached to all or part of the main body 141, being specifically rotatable around the shutter axis X140.

The support 153 advantageously includes two half-shells 153.1 and 153.2 that delimit the compartment V153 between them: in the assembled state of the actuating device 150, the half-shells 153.1 and 153.2 are assembled in a fixed and sealed manner to each other. In the assembled state of the valve 101, at least one of the two half-shells 153.1 and 153.2 is fixedly assembled to the housing 110: in the example considered in the figures, the half-shell 153.1 is thus assembled to the housing 110 in FIG. 9 while the half-shell 153.2 is fixedly assembled to the half-shell 153.1 in FIGS. 8 and 9 but is removed in FIGS. 10 and 11.

The electric motor 151 is functionally or even structurally similar to the electric motor 51 of the actuating device 50, as here. In particular, the electric motor 151 is provided with a drive output 155 similar to the drive output 55: the drive output 155 is thus rotatable around a motor axis X151 relative to the support 153 and is provided with a leading gearing 155.1 similar to the leading gearing 55.1.

The transmission system 152 is functionally similar to the transmission system 52 of the actuating device 50 and, in this regard, connects the drive output 155 to the shutter 140 so that a rotation of the drive output 155 around the motor axis 151 drives the shutter 140 in movement to regulate the fluid through the valve 101, here driving at least the head 143 of the shutter 140 in rotation around the shutter axis X140, for example. The transmission system 152 comprises a succession of gear wheels, which is functionally similar to the succession of gear wheels 56, 57, and 58 of the transmission system 52. Each of the gear wheels of the transmission system 152 is supported by the support 153 in a mobile manner in rotation around a wheel axis on which the concerned gear wheel is centered.

At “the input” of the succession of gear wheels of the transmission system 152 is the gear wheel 56, which has been described in detail above in connection with the actuating device 50 and which is shown alone in FIGS. 6 and 7. In the assembled state of the actuating device 150, the electric motor 151 and the gear wheel 56 are arranged so that the wheel axis X56 of the gear wheel 56 is perpendicular to the motor axis X151, on the one hand, and, on the other, the leading gearing 155.1 of the drive output 155 is meshed by the second driven gearing 56.2 of the gear wheel 56 while the first driven gearing 56.1 is left free and the rest of the transmission system 152 is advantageously meshed by the driving hub 56.3 of the gear wheel 56.

Thus, taking into account the explanations given so far, it is understood that the gear wheel 56 has the advantage of being able to be used both when its wheel axis X56 is parallel to the motor axis X151, as in the actuating device 50, and when its wheel axis X56 is perpendicular to the motor axis X151, as in the actuating device 150. Indeed, the two driven gearings 56.1 and 56.2 of the gear wheel 56 are selectively meshed with the drive output 55 or 155, depending on whether the wheel axis X56 is parallel or perpendicular to the motor axis of this drive output. In other words, the gear wheel 56 is designed so that:
when the wheel axis X56 is parallel to the motor axis of the drive output, as is the case for the actuating device 50, the first driven gearing 56.1 meshes with the leading gearing 55.1 of the drive output 55 during the rotation of the gear wheel 56 around its wheel axis X56, while the second driven gearing 56.2 is left free, and
when the wheel axis X56 is perpendicular to the motor axis of the drive output, as in the actuating device 150, the second driven gearing 56.2 meshes with the leading gearing 155.1 of the drive output 155 during the rotation of the gear wheel 56 around its wheel axis X56, while the first driven gearing 56.1 is left free.

Moreover, regardless of which of the first and second driven gearings 56.1 and 56.2 is meshed by the leading gearing of the drive output 55 or 155, the driving hub 56.3 of the gear wheel 56 advantageously meshes with the rest of the transmission system 52 or 152. Returning to the description of the transmission system 152, it should be noted that, at “the output” of the succession of gear wheels of the latter is a gear wheel 157, which is functionally or even structurally similar to the gear wheel 57 of the actuating device 50 and which, in particular, engages the shutter 140, here with the head 143 of the latter. The gear wheel 56 and the gear wheel 157 are connected to each other by the other gear wheels of the aforementioned succession of gear wheels, which are referenced 158 and which are functionally or even structurally similar to the intermediate gear wheels 58 of the actuating device 50.

Moreover, the electric motor 151 is advantageously electrically connected, here inside the compartment V153, to a connector 153.3 integrated into the support 153, here into the half-shell 153.2. This connector 153.3, outside the actuating device 150 and the valve 101, is designed to be connected to an external harness, not shown, to electrically connect the actuating device 150 to one or more external units, which are not shown and which include a power supply source, such as the one mentioned above in connection with the valve 1. According to one possible embodiment, the aforementioned external units include one or more control and/or supervision units, such as an onboard computer of the vehicle to the cooling circuit of which the valve 101 belongs: the or one of these control and/or supervision units is advantageously designed to control the electric motor 151, by sending it ad hoc control electrical signals, via the external harness. According to another possible embodiment, the control of the electric motor 151 is operated by an electronic device, which belongs to the actuating device 150 and which is advantageously housed in the compartment V153, being specifically integrated into the electrical connection between the connector 153.3 and the electric motor 151: this electronic device, which is not shown in the figures, is adapted to send the electric motor 151 electrical control signals and, where applicable, power supply signals.

FIGS. 12 to 14 show a gear wheel 256 as a variant of the gear wheel 56 described thus far. The gear wheel 256 is centered on a wheel axis X256 and is provided with:
a first driven gearing 256.1, which is functionally or even structurally similar to the first driven gearing 56.1 of the gear wheel 56, being specifically arranged on a lateral face 256A of the gear wheel 256, similar to the lateral face 56A of the gear wheel 56,
a second driven gearing 256.2, which is functionally or even structurally similar to the second driven gearing 56.2 of the gear wheel 56, being specifically arranged on one of the two frontal faces 256B and 256C of the gear wheel 256, similar to the frontal faces 56B and 56C of the gear wheel 56, the second gearing 256.2 being thus arranged here on the frontal face 256B,
a driving hub 256.3, which is functionally or even structurally similar to the driving hub 56.3 of the gear wheel 56, and
a third driven gearing 256.4, which is distinct from the driven gearings 256.1 and 256.2 and which extends around the wheel axis X256, being advantageously arranged on the frontal face 256C of the gear wheel 256.

The gear wheel 256 is designed to equip an electromechanical actuating device, not represented in its entirety, which is functionally similar to the actuating devices 50 and 150 described above and which, in particular, includes both a support, similar to the support 53 or 153, an electric motor, similar to the electric motor 51 or 151, and a mechanical transmission system, similar to the transmission system 52 or 152 and to which the gear wheel 256 belongs. In the assembled state of the aforementioned actuating device, the gear wheel 256 is supported by the aforementioned support in a mobile manner in rotation around the wheel axis X256 and is designed so that a leading gearing of a rotary drive output of the aforementioned electric motor meshes selectively with the respective first driven gearing 256.1, second driven gearing 256.2 or third driven gearing 256.4, depending on whether the wheel axis X256 is parallel, perpendicular, or inclined relative to the motor axis around which this drive output is rotary, and this with meshing of the driving hub 256.3 with the rest of the aforementioned transmission system. In particular, the gear wheel 256 is designed so that, when the wheel axis X256 and the aforementioned motor axis are inclined relative to each other, forming between them an angle that is different from 90° and which is 45°, for example, the third driven gearing 256.4 meshes with the leading gearing of the drive output during the rotation of the gear wheel 256 around the wheel axis X256. To this end, the third driven gearing 256.4 is a conical gearing, for example.

In a non-represented variant, the gear wheel is provided with several third driven gearings, which are each similar to the driven gearing 256.4 but which are respectively associated with different values of the aforementioned angle.

Finally, various arrangements and variants to the actuating devices and valves described thus far are also conceivable:
the number of gear wheels belonging to the transmission system whose “input” is constituted by the gear wheel 56 or 256 is not necessarily equal to four, as envisaged in the examples illustrated in the figures, but can be limited to two or three, or be equal to a number greater than four, for example;
the part of the transmission system that connects the gear wheel 56 or 256 to a shutter to be driven in movement by this transmission system, can take gear forms other than gear wheels, such as the gear wheels 57 and 58 or 157 and 158, these other gear forms being specifically adapted to the specifics of the kinematics of the shutter to be driven in movement in the internal volume of the housing of a valve to regulate the fluid through the latter;
the number of outlets of the housing of the valve is not necessarily equal to four, as envisaged in the figures, but can be limited to two or three, or be equal to a number greater than four, for example; and/or
in the embodiment illustrated in FIGS. 1 to 5, the pump 30 may not be integrated into the valve 1, but be separate from the latter; this means that the valve then does not include the pump 30 and that the internal volume V11 can be limited to the sub-volume V11.2, with a corresponding adaptation of the body 11 of the housing 10 and a hose connection of the discharge of this remote pump with the inlet of the housing of the valve; this, of course, is applicable to the valve 101.

What is claimed is:

1. An electromechanical actuating device for a fluid distribution valve, comprising:
a support,
an electric motor, which is supported by the support and which is provided with a drive output, which is rotatable around a motor axis relative to the support and which is provided with a leading gearing, and
a mechanical transmission system, which is supported by the support and which is capable of connecting the drive output to a shutter of a fluid distribution valve so that a rotation of the drive output around the motor axis drives the shutter in movement to regulate a fluid through the fluid distribution valve,
wherein the transmission system includes a gear wheel which is supported by the support in a mobile manner in rotation around a wheel axis X256) on which the gear wheel is centered, the gear wheel being provided with both:
two frontal faces, which extend transversely to the wheel axis,
a lateral face, which extends in the direction of the wheel axis and which connects the two frontal faces to each other,
a first driven gearing, which is arranged on the lateral face and which, during the rotation of the gear wheel around the wheel axis, is adapted to mesh with the leading gearing of the drive output when the wheel axis and the motor axis are substantially parallel to each other,
a second driven gearing, which is arranged on a first of the two frontal faces and which, during the rotation of the gear wheel around the wheel axis, is adapted to mesh with the leading gearing of the drive output when the wheel axis and the motor axis are substantially perpendicular to each other, and
a driving hub, which is centered on the wheel axis, extending from the first frontal face, and which meshes with the rest of the transmission system when the leading gearing of the drive output meshes indifferently with one of the first and second driven gearings.

2. The electromechanical actuating device according to claim 1, wherein the first driven gearing is a straight gearing.

3. The electromechanical actuating device according to claim 1, wherein the first driven gearing is a helical gearing.

4. The electromechanical actuating device according to claim 1, wherein the second driven gearing is a dog faced gearing.

5. The electromechanical actuating device according to claim 1, wherein the gear wheel is also provided with at least one third driven gearing which, during the rotation of the gear wheel around the wheel axis, is adapted to mesh with the leading gearing of the drive output when the wheel axis and the motor axis are inclined relative to each other forming between them an angle that is different from 90°.

6. The electromechanical actuating device according to claim 5, wherein the third driven gearing is arranged on the second of the two frontal faces of the gear wheel.

7. The electromechanical actuating device according to claim 5, wherein the driving hub meshes with the rest of the transmission system when the leading gearing of the drive output meshes indifferently with one of the first, second, and third driven gearings.

8. The electromechanical actuating device according to claim 1, wherein the transmission system is capable of connecting the drive output to the shutter so that a rotation of the drive output around the motor axis drives at least a part of the shutter in rotation around a shutter axis which is substantially parallel to the wheel axis.

9. A fluid distribution valve comprising:
an electromechanical actuating device according to claim 1,
a housing, which is fixedly attached to the support and which defines an internal volume through which a fluid passes through the housing, this internal volume being connected to the outside of the housing by an inlet of the housing, through which the fluid enters the internal volume, and by outlets of the housing, through which the fluid exits the internal volume, and
a shutter, which is arranged in the internal volume in a movable manner relative to the housing to control the opening/closing of the outlets of the housing, the shutter being driven in movement by the electromechanical actuating device.
